(19) United States
(12) Patent Application Publication
(10) Pub. No.: US 2013/0255034 A1
(43) Pub. Date: Oct. 3, 2013

(54) MULTI-PURPOSE CASTER AND METHOD OF USING SAME

(71) Applicants: Matthew Smith, Wooster, OH (US); Mitchell Balley, Westlake, OH (US)

(72) Inventors: Matthew Smith, Wooster, OH (US); Mitchell Balley, Westlake, OH (US)

(73) Assignee: Waxman Consumer Products Group Inc., Bedford Heights, OH (US)

(21) Appl. No.: 13/852,531

(22) Filed: Mar. 28, 2013

Related U.S. Application Data
(60) Provisional application No. 61/617,104, filed on Mar. 29, 2012.

(51) Int. Cl. B60B 33/00

(52) U.S. Cl. CPC B60B 33/00
USPC 16/31 R

(57) ABSTRACT

A multi-purpose caster and method of using same includes a yoke arrangement having a body supporting a first portion of a spindle. The spindle further comprises a second portion projecting away from the body for insertion into an object during use. The yoke arrangement also includes spaced first and second arms forming a well therebetween. The arms secure an axle that passes through the well during assembly. A selection assembly is rotatably connected to the axle. The selection assembly includes at least two transfer mechanisms of differing modes of movement capable of selectable rotation within the well.

### CROSS REFERENCES TO RELATED APPLICATIONS

The following application claims priority to co-pending U.S. Provisional Patent Application Ser. No. 61/617,104 filed Mar. 29, 2012 entitled MULTI-PURPOSE CASTER AND METHOD OF USING SAME assigned attorney docket number WAX-021068 US PRO. The above-identified application is incorporated herein by reference in its entirety for all purposes.

### TECHNICAL FIELD

The present disclosure relates to a multi-purpose caster and method of using same, and more particularly, a multi-purpose caster that is secured to an object to be moved that includes a plurality of selectable surfaces that can be adjusted to the selectable surface that would allow for movement of the object across differing types of surfaces or flooring with the least amount of force being applied to the object.

### BACKGROUND

Objects such as furniture or chairs typically employ conventional casters adapted to a base or legs extending from the objects. Conventional casters are typically in contact with the floor and facilitate movement of the object across the floor's surface by reducing the friction between the floor and the object.

Conventional casters also facilitate a reduction in the surface wear as the furniture is moved about the floor. This is especially apparent in chairs that are frequently moved in and out about the floor from a table or desk. The bottoms of the feet of the chairs are prone to scratch and wear the floor over time, causing unsightly marks and form wear patterns, especially on wooden floors.

One conventional type of caster comprises either a sphere or disc wheels that swivel on an axle as the object moves across the floor. The axles are typically supported by a central post received in each leg of the object. The construction of a conventional caster and method of attachment into a leg of an object or chair is further shown in FIG. 1-3 and described in U.S. Pat. No. 6,748,623 to Tsai. U.S. Pat. No. 6,748,623 is incorporated herein by reference in its entirety.

### SUMMARY

One example embodiment of the present disclosure includes a multi-purpose caster having a yoke arrangement with a body supporting a first portion of a spindle. The spindle further comprises a second portion projecting away from the body for insertion into an object during use. The yoke arrangement also includes spaced first and second arms forming a well therebetween. The arms secure an axle that passes through the well during assembly. A selection assembly is rotatably connected to the axle. The selection assembly includes at least two transfer mechanisms of differing modes of movement capable of selectable rotation within the well.

Another example embodiment of the present disclosure includes a method of changing the mode of movement in a multi-purpose caster for coupling to an object. The method comprises the steps of providing a yoke arrangement having a body for supporting a first portion of a spindle, the spindle further comprises a second portion projecting away from the body for insertion into an object during use. The method also comprises forming a well between spaced first and second arms that project from a body of the yoke arrangement and securing an axle that passes through the well during assembly to the first and second arms. The method further comprises rotatably connecting a selection assembly to the axle, the selection assembly comprising at least two transfer mechanisms of differing modes of movement capable of selectable rotation within the well.

While another example embodiment of the present disclosure comprises a multi-purpose caster for attaching to and facilitating the movement of furniture, the multi-purpose caster comprises a yoke arrangement having a body supporting a first portion of a spindle, the spindle further comprising a second portion projecting away from the body for insertion into an object during use. The yoke arrangement further comprises spaced first and second arms forming a well therebetween, the arms securing an axle that passes through the well during assembly. The multi-purpose caster also comprises a triangularly shaped selection assembly selectively rotatably connected to the axle and spaced between the first and second arms, the selection assembly comprises a plurality of transfer mechanisms comprising three different modes of movement across a surface during use, the first mode comprising a surface structure capable of rolling, the second mode comprising a surface structure capable of sliding, and the third mode comprising a surface structure capable of gliding.

### BRIEF DESCRIPTION OF THE DRAWINGS

The foregoing and other features and advantages of the present disclosure will become apparent to one skilled in the art to which the present invention relates upon consideration of the following description of the invention with reference to the accompanying drawings, wherein like reference numerals refer to like parts unless described otherwise throughout the drawings and in which:

FIG. 1 is a perspective view of a conventional caster;

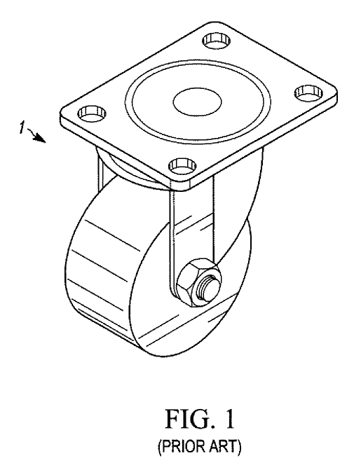

FIG. 2 is an exploded perspective view of another conventional caster;

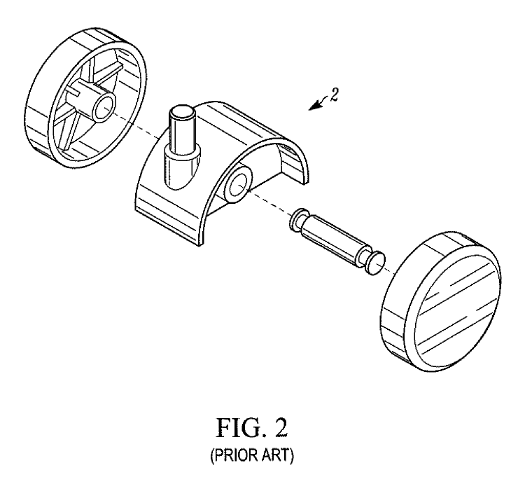

FIG. 3 is an exploded perspective view of another conventional casters;

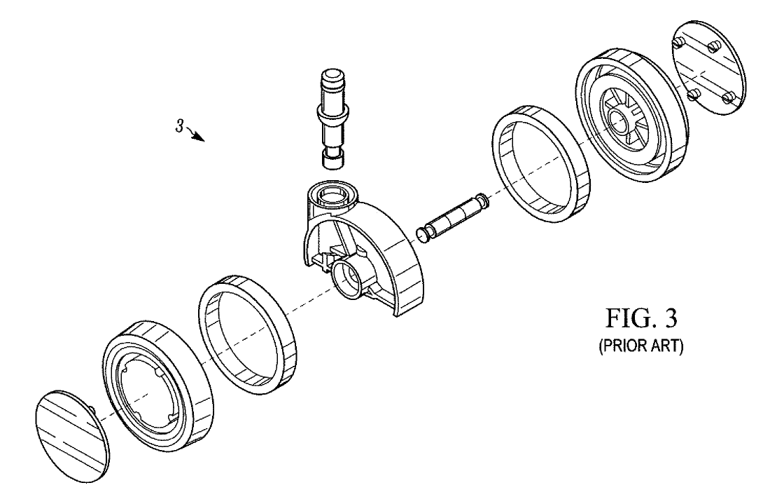

FIG. 4 is exploded perspective view of a multi-purpose caster constructed in accordance with one example embodiment of the present disclosure;

FIG. 5 is a partial exploded perspective view of a selection assembly constructed in accordance with one example embodiment of the present disclosure;

FIG. 6 is a side elevation view of the multi-purpose caster of FIG. 4 in a rolling position;

FIG. 7 is a side elevation view of the multi-purpose caster of FIG. 4 in a gliding position; and

FIG. 8 is a side elevation view of the multi-purpose caster of FIG. 4 in a sliding position.

### DETAILED DESCRIPTION

Referring now to the figures generally wherein like numbered features shown therein refer to like elements throughout unless otherwise noted. The present disclosure relates to a multi-purpose caster 10 and method of using same, and more particularly, a multi-purpose caster 10 that is secured to an object to be moved that includes a plurality of selectable surfaces that can be adjusted to the selectable surface that would allow for movement of the object across differing types of surfaces or flooring with the least amount of force being applied to the object.

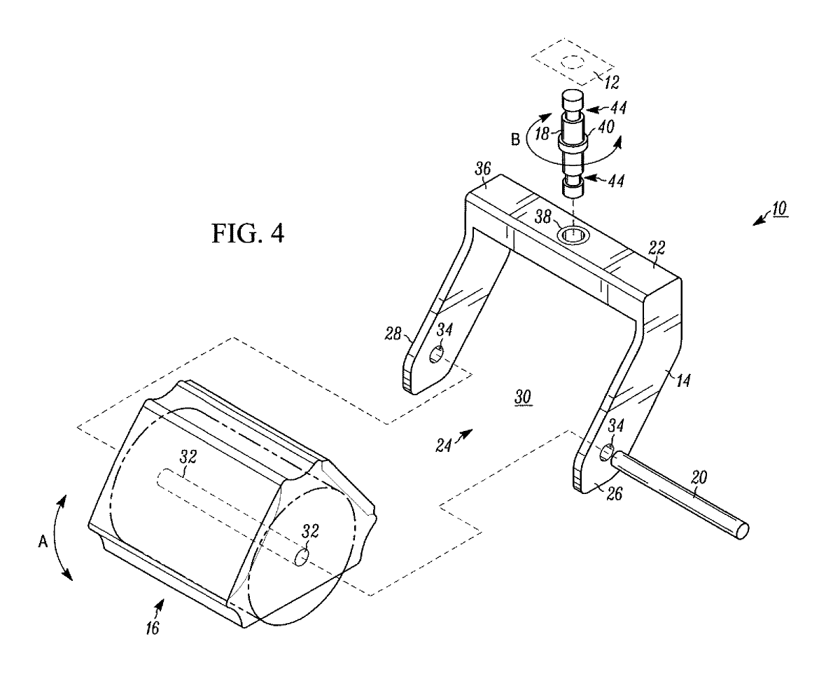

FIG. 4 illustrates a perspective view of a multi-purpose caster 10 constructed in accordance with one example embodiment of the present disclosure secured to an object 12 such as a leg of a chair or other types of furniture. It should be appreciated by one of ordinary skill in the art that multiple multi-purpose casters 10 could be used, for example four casters 10, one on each of four legs of a chair. The assembly, construction, and operation of one is described below in detail however for simplicity.

The multi-purpose caster 10 includes a yoke arrangement 14, selection assembly 16, spindle 18, and axle 20. The yoke arrangement 14 in one example embodiment is formed from molded plastic and secures the selection assembly 16 to the object 12. The selection assembly 16 protects the floor from the object 12 and provides a plurality of transfer mechanisms that can be selected to best suit the mobility of the object with the type of flooring surface.

The yoke arrangement 14 includes a body 22 forming a yoke 24 by spaced first and second arms 26, 28, respectively projecting out from the body. The yoke 24 provides a well or cavity 30 that allows for free, 360 degree rotation (both clock-wise and counter clock-wise) of the selection assembly 16 when supported between the arms 26, 28, as shown by arrows A in FIG. 4. The selection assembly 16 is rotatably mounted on the axle 20 that passes through a central hub 32 when supported in the well 30. In the illustrated example embodiment, the axle 20 is made from metal, such as 1020 SAE steel.

The axle 20 during assembly passes through and is secured in a bushing aperture 34 located in each of the arms 26, 28. In the illustrated example embodiment, the aperture 34 is a sufficient press fit size to allow for a single resistant passage of the axle 20 during assembly, yet stable enough to prevent disassembly during operation of the multi-purpose caster 10, during movement of the object 12.

Located along an engagement surface 36 of the body 22 is a receiving aperture 38 for securing the spindle in a rotatable connection, allowing for free, 360 degree rotation (both clock-wise and counter clock-wise) direction of the multi-purpose caster 10 relative to the object 12, as indicated by arrows B in FIG. 4. The spindle 18 in the illustrated example embodiment is constructed from metal such as SAE 1020 steel, and includes an annular collar 40 turned into the spindle for rotatable nesting in a recess 42 concentrically formed about the receiving aperture 38 in the engagement surface 36.

The multi-purpose caster 10 and object 12 can individually or collectively rotate relative to one another about the spindle 18 during operation. The object 12 has a corresponding recess in the bottom of the object for rotatable nesting, similar to the operation described within the yoke arrangement 14. The spindle 18 in the illustrated example embodiment further comprises spaced undercuts 44 at opposite ends for engaging the object 12 and yoke arrangement 14. Such engagement includes snap-ring securing arrangement as would be appreciated by one of ordinary skill in the art when the spindle 18 is inserted into the receiving aperture 38 and a corresponding similarly constructed aperture in the object 12 during assembly.

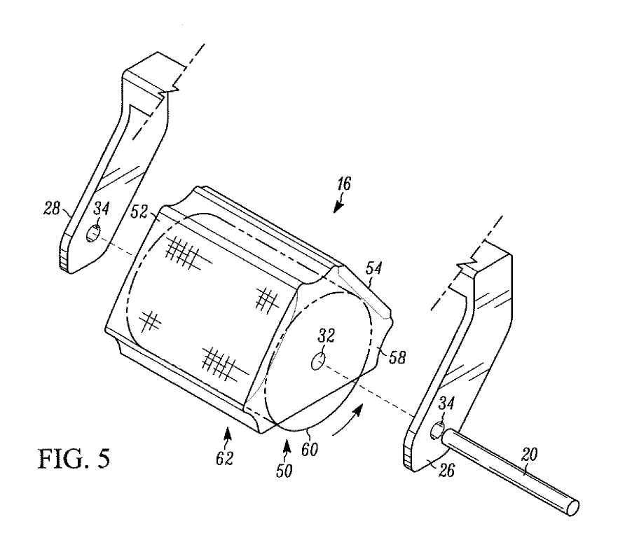

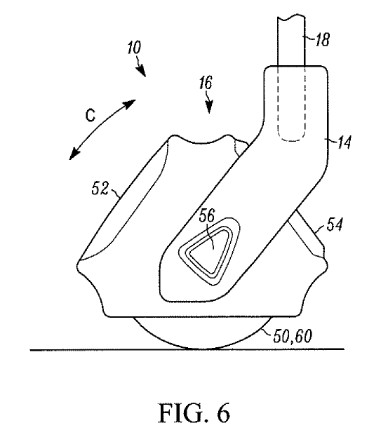

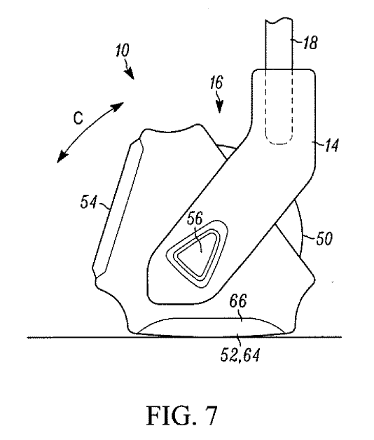

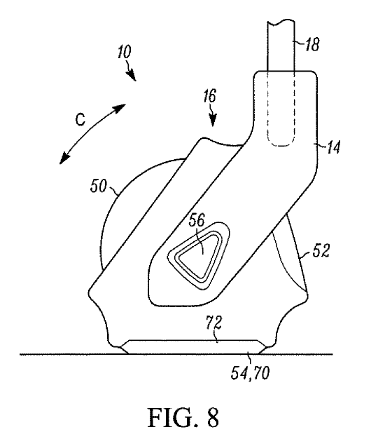

Referring now to FIG. 5 is a more detail perspective view of the selection assembly 16. The selection assembly 16 comprises three transfer mechanisms 50, 52, and 54 that can be selected by the user of the multi-purpose caster 10 to best suit the mobility of the object 12 with the type of flooring surface. In the illustrated example embodiments of FIGS. 6-8, the mode of movement in the transfer mechanism selected is a roller mechanism 50 (FIG. 6), a gliding mechanism 52 (FIG. 7), and a sliding mechanism 54 (FIG. 8).

As illustrated in the example embodiments of FIGS. 6-8, the selection assembly 16 is freely rotatable about the axle 20 within the well 30 for 360 degree rotation (both clock-wise and counter clock-wise), as indicated by arrows C. In one example embodiment, the rotation of the selection assembly 16 is permitted only after depressing a release 56 that is located on arms 26, 28, that includes a detent that engages a housing 58 of the selection assembly until depressed. Once the release 56 is depressed, the selection assembly 16 and housing 58 are free to rotate to the desired position of transfer mechanism 50, 52, and 54. It should be appreciated by one of ordinary skill in the art that selection of the transfer mechanism 50, 52, or 54 would be the same transfer mechanism selected for each of the multi-purpose casters 10 connected to each of the legs of the object 12.

The housing 58 of the selection assembly 16 in the illustrated example embodiment is triangularly shaped body formed from plastic, exposing one transfer mechanism 50, 52, and 54 on each side. In the example embodiment of FIGS. 5-6, the transfer mechanism 50 selected to engage the floor is a roller mechanism 60. The roller mechanism 60 in the illustrated example embodiment is made of plastic or metal and is a wheel that rotates within a clearance cavity 62 of the housing 58 about and on the axle 20 that passes through the center of the roller mechanism. In one example embodiment, the roller mechanism 60 is a sphere. In another example embodiment, the roller mechanism 60 is a cylindrical wheel, similarly constructed as the caster shown in U.S. Pat. No. 6,748,623, which is incorporated herein by reference. The roller mechanism 60 is selected by users of the object 12 by rotating the housing 58 so that the roller engages the floor. The roller mechanism 60 is selected by the user, for example, when the surface engaging the multi-purpose caster is hard, yet bumpy, such as wood, tile, and the like.

In the example embodiment of FIG. 7, the transfer mechanism 52 selected to engage the floor is a gliding mechanism 64, such as a flat plastic insert or a flat metal insert partially secured within a recess 66 formed within the housing 58. The gliding mechanism 64 includes a riser 68 that limits the engagement with the floor, minimizing surrounding contact and friction between the multi-purpose caster 10 and the floor. The glider mechanism 64 is elected by users of the object 12, for example, when the surface engaging the multi-purpose caster 10 is pliable, such as carpet, artificial grass, and the like.

In the example embodiment of FIG. 8, the transfer mechanism 54 selected to engage the floor is a sliding mechanism 70, such as a felt insert or a fabric insert partially secured within a recess 72 formed within the housing 58. The sliding mechanism 70 engages the floor, minimizing surrounding contact and friction between the multi-purpose caster 10 and the floor. The slider mechanism 70 is elected by users of the object 12, for example, when the surface engaging the multi-purpose caster 10 is hard, yet relatively smooth, such as laminated floors, linoleum, and the like.

In the illustrated example embodiments, the glider mechanism 64 and slider mechanism 70 are secured in their respective recesses by an adhesive, but could be additionally secured by a fastener and/or both, advantageously allowing replacement mechanisms to be inserted into the housing 58, if significant wear is experienced or for using a different type of mechanism material for the floor being encountered.

Unlike conventional casters that are typically suitable for a single floor type, the transfer mechanisms 50, 52, and 54 advantageously allow the multi-purpose casters 10 associated with the object 12 to be used independent of the floor material on which the object moves. Thus, such an advantage reduces the cost associated with having different types of casters being sent with the objects 12, and the assembly costs with changing out the conventional casters from the objects. While three different transfer mechanisms 50, 52, and 54 are shown, it should be appreciated that any number of transfer mechanisms for handling different floor surfaces could be incorporated into the selection assembly 16 without departing from the spirit and scope of the claimed disclosure.

As used herein, terms of orientation and/or direction such as upward, downward, forward, rearward, upper, lower, inward, outward, inwardly, outwardly, horizontal, horizontally, vertical, vertically, distal, proximal, axially, radially, etc., are provided for convenience purposes and relate generally to the orientation shown in the Figures and/or discussed in the Detailed Description. Such orientation/direction terms are not intended to limit the scope of the present disclosure, this application and the invention or inventions described therein, or the claims appended hereto.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A multi-purpose caster comprising:
a yoke arrangement having a body supporting a first portion of a spindle, the spindle further comprising a second portion projecting away from the body for insertion into an object during use;
the yoke arrangement further comprising spaced first and second arms forming a well therebetween, the arms securing an axle that passes through the well during assembly; and
a selection assembly rotatably connected to said axle, selection assembly comprises at least two transfer mechanisms of differing modes of movement capable of selectable rotation within said well.

2. The multi-purpose caster of claim 1 wherein said transfer mechanisms includes three modes of movement, the first mode comprising a surface structure capable of rolling, the second mode comprising a surface structure capable of sliding, and the third mode comprising a surface structure capable of gliding.

3. The multi-purpose caster of claim 2 wherein said surface structure capable of rolling comprises one of a cylindrical wheel and a spherical wheel.

4. The multi-purpose caster of claim 1 further comprising a release that allows said selection assembly to selectively rotate about said axle between different transfer mechanisms.

5. The multi-purpose caster of claim 2 wherein said surface structure capable of sliding comprises one of felt or fabric.

6. The multi-purpose caster of claim 2 wherein said surface structure capable of gliding comprises one of a metal insert and a plastic insert.

7. A method of changing the mode of movement in a multi-purpose caster for coupling to an object, the method comprising the steps of:
providing a yoke arrangement having a body for supporting a first portion of a spindle, the spindle further comprising a second portion projecting away from the body for insertion into an object during use;
forming a well between spaced first and second arms that project from a body of said yoke arrangement,
securing an axle that passes through the well during assembly to said first and second arms; and
rotatably connecting a selection assembly to said axle, the selection assembly comprising at least two transfer mechanisms of differing modes of movement capable of selectable rotation within said well.

8. The method of claim 7 wherein said modes of movement comprises three modes of movement, the first comprising a surface structure capable of rolling, the second comprising a surface structure capable of sliding, and the third comprising a surface structure capable of gliding.

9. A multi-purpose caster for attaching to and facilitating the movement of furniture, the multi-purpose caster comprising:
a yoke arrangement having a body supporting a first portion of a spindle, the spindle further comprising a second portion projecting away from the body for insertion into an object during use;
the yoke arrangement further comprising spaced first and second arms forming a well therebetween, the arms securing an axle that passes through the well during assembly; and
a triangularly shaped selection assembly selectively rotatably connected to said axle and spaced between said first and second arms, selection assembly comprises a plurality of transfer mechanisms comprising three different modes of movement across a surface during use, the first mode comprising a surface structure capable of rolling, the second mode comprising a surface structure capable of sliding, and the third mode comprising a surface structure capable of gliding.

10. The multi-purpose caster of claim 9 wherein said surface structure capable of rolling comprises one of a cylindrical wheel and a spherical wheel.

11. The multi-purpose caster of claim 9 further comprising a release that allows said selection assembly to selectively rotate about said axle between different transfer mechanisms.

12. The multi-purpose caster of claim 9 wherein said surface structure capable of sliding comprises one of felt or fabric.

13. The multi-purpose caster of claim 9 wherein said surface structure capable of gliding comprises one of a metal insert and a plastic insert.

14. The multi-purpose caster of claim 12 wherein said felt or fabric is replaceably connected.

15. The multi-purpose caster of claim 9 further comprising a kit of a plurality of multi-purpose casters to be connected to and facilitate the movement of furniture.
